(19) United States
(12) Patent Application Publication
(10) Pub. No.: US 2014/0063398 A1
(43) Pub. Date: Mar. 6, 2014

(54) DISPLAY PANEL AND REPAIRING METHOD THEREOF

(71) Applicant: AU OPTRONICS CORPORATION, Hsinchu (TW)

(72) Inventors: Chun-Huan Chang, New Taipei City (TW); Chun-Hsin Liu, Yunlin County (TW); Kun-Yueh Lin, Chiayi County (TW); Ya-Ting Lin, Taichung City (TW); Shu-Fang Hou, Chiayi County (TW); Che-Wei Tung, Taichung City (TW); Wei-Li Lin, Changhua County (TW)

(73) Assignee: AU OPTRONICS CORPORATION, Hsinchu (TW)

(21) Appl. No.: 13/831,927

(22) Filed: Mar. 15, 2013

(30) Foreign Application Priority Data
Sep. 3, 2012 (TW) 101132032

(51) Int. Cl. G02F 1/1362

(52) U.S. Cl. CPC G02F 1/136259
USPC 349/54; 349/192

(57) ABSTRACT

A display panel is provided. A substrate includes a non-display area and a display area including a center area, a first area, and a second area. First data lines are disposed in the first area and electrically connected to the first source driving circuit. Second data lines are disposed in the second area and electrically connected to the second source driving circuit. At least one first repairing line is electrically connected to the first source driving circuit, passes through the center area of the display area and overlaps with the first data lines, wherein the first repairing line is electrically insulated from the first data lines. At least one second repairing line is electrically connected to the second source driving circuit, passes through the center area of the display area and overlaps with the second data lines, wherein the second repairing line is electrically insulated from the second data lines.

### CROSS-REFERENCE TO RELATED APPLICATION

This application claims the priority benefit of Taiwan application serial no. 101132032, filed on Sep. 3, 2012. The entirety of the above-mentioned patent application is hereby incorporated by reference herein and made a part of this specification.

### BACKGROUND OF THE INVENTION

1. Field of the Invention

The invention relates to a display panel and a repairing method thereof and more particularly relates to a display panel having an hG2D (half gate and two data) structure plus dual-portrait framework and a repairing method thereof.

2. Description of Related Art

The frame rate of a general liquid crystal display is 60 Hz, which means that the frame is renewed 60 times per second. Higher frame rate means that the liquid crystal display has better image quality. In order to display dynamic images with better quality, liquid crystal displays with frame rates of 120 Hz and 240 Hz are now available in the market. However, as the frame rate increases, the charging time for each pixel is reduced correspondingly, wherein charging time=(1/frame rate)/total number of scan lines. For example, in the case that the resolution of a display panel is 4K2K (i.e. 3840*2160), and the frame rate is 120 Hz, the charging time for each pixel is equal to 1/(120*2160)≈3.8 μs. In this example, the charging time is too short to charge the pixel to the correct voltage level, and as a result, the pixel cannot display the correct gray scale (i.e. image distortion) and the image quality of the liquid crystal display is impaired. Considering the above, an hG2D plus dual-portrait framework and a driving method thereof have been developed.

A display panel having the hG2D structure includes two data lines disposed between two columns of pixels. In each column of the pixels, two pixels that are adjacent in the vertical direction are coupled to different data lines, and two rows of the pixels are charged in one scan time (2D). Thus, N rows of the pixels require N/2 of progressive scan times (hG). That is, the charging time for each pixel in the display panel with hG2D framework is double of the charging time for the general (1G1D) display panel. The dual-portrait framework includes two sets of gate driving circuits at the side with resolution of 3840 and a source driving circuit at the side with resolution of 2160. The two sets of gate circuits are insulated from each other, and each set of the circuits is used for scanning 1920 lines of gates. In the case that the frame rate is 120 Hz, the charging time for each pixel is 1/(120*1920)≈4.3 μs. With the hG2D structure, the charging time is doubled (8.6 μs). Compared with 3.8 μs, the charging time is made more sufficient and each of the pixels can be charged to correct gray scale, so as to improve the image quality of the liquid crystal display. However, in the process of fabricating the display panel with hG2D plus dual-portrait framework, the display panel may have open circuit problem if the data line has a defect. When the aforementioned problem occurs, the display panel has to be repaired, such that the display panel can function properly.

### SUMMARY OF THE INVENTION

The invention provides a display panel which includes a repairing line disposed in a display area and has a better yield rate.

The invention provides a repairing method of a display panel for repairing the display panel with a repairing line, so as to improve the yield rate of the display panel.

The invention provides a display panel which includes a substrate, a first source driving circuit, a second source driving circuit, a plurality of scan lines, a plurality of data lines, a plurality of pixel units, at least one first repairing line, and at least one second repairing line. The substrate includes a display area and a non-display area, wherein the display area includes a center area, a first area, and a second area. The first area and the second area are located at two sides of the center area. The first source driving circuit and the second source driving circuit are disposed in the non-display area at two opposite sides of the display area. The scan lines are disposed in the display area. The data lines are disposed in the display area. The data lines include a plurality of first data lines and a plurality of second data lines. The first data lines are disposed in the first area and electrically connected to the first source driving circuit. The second data lines are disposed in the second area and electrically connected to the second source driving circuit. The second data lines and the first data lines are disposed in parallel to each other and electrically insulated from each other. The pixel units are located in the display area, and each of the pixel units is electrically connected to one of the scan lines and one of the data lines. The first repairing line is electrically connected to the first source driving circuit. The first repairing line passes through the center area of the display area and overlaps with the first data lines, wherein the first repairing line is electrically insulated from the first data lines. The second repairing line is electrically connected to the second source driving circuit. The second repairing line passes through the center area of the display area and overlaps with the second data lines, wherein the second repairing line is electrically insulated from the second data lines.

The invention provides a repairing method of a display panel, including the following steps. First, the aforementioned display panel is provided, wherein one of the first data lines has a first open circuit defect. Then, a first welding process is performed on an overlapping area between the first data line having the first open circuit defect and the first repairing line, so as to electrically connect the first data line to the first repairing line.

Based on the above, the display panel of the invention includes the repairing line disposed in the display area. When the data line in the display panel has the open circuit defect, the welding process is used to electrically connect the repairing line with the broken data line, so as to improve the yield rate of the display panel.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view of a display panel according to an embodiment of the invention.

FIG. 2 is a schematic top view of an active device array substrate according to this embodiment.

FIG. 3 illustrates an open circuit defect that occurs on the active device array substrate of the display panel of this embodiment.

FIG. 4 illustrates the active device array substrate of the display panel of FIG. 3 undergoing a repairing process.

FIG. 5 is a schematic top view of an active device array substrate of a display panel according to another embodiment of the invention.

FIG. 6 is an enlarged view of an area M of FIG. 5.

FIG. 7 is a schematic top view of an active device array substrate of a display panel according to yet another embodiment of the invention.

### DESCRIPTION OF THE EMBODIMENTS

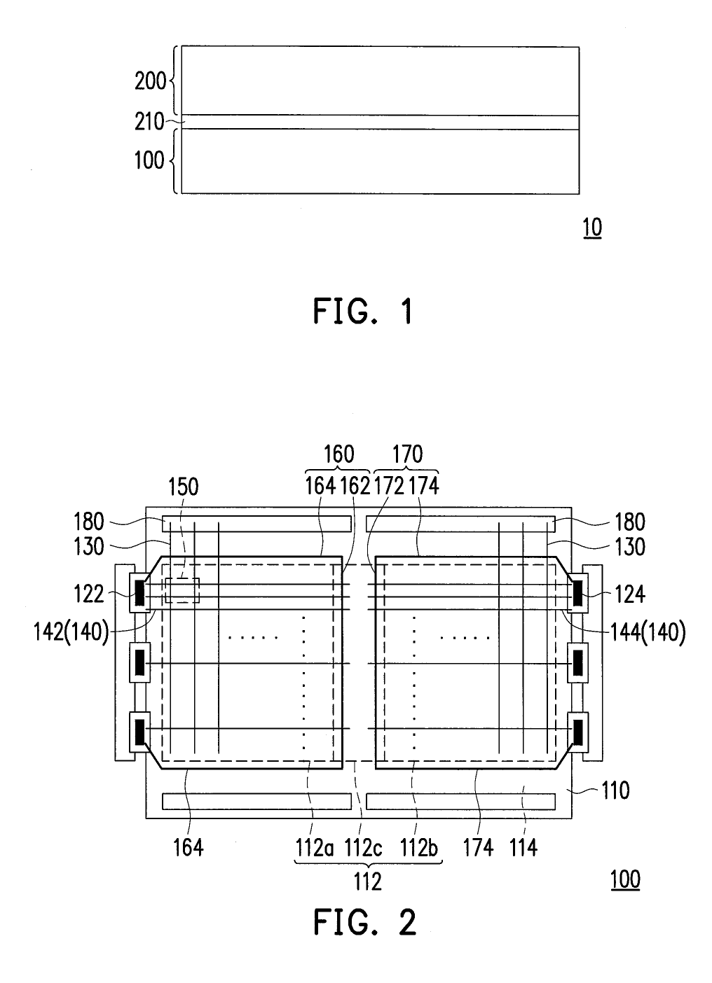

FIG. 1 is a schematic cross-sectional view of a display panel according to an embodiment of the invention. Referring to FIG. 1, a display panel 10 includes an active device array substrate 100 and an opposite substrate 200. It should be noted that the invention does not restrict the display panel 10 to a certain type. That is to say, the display panel 10 may be a liquid crystal display panel, an organic light emitting diode display panel, or any display panel including the active device array substrate 100.

FIG. 2 is a schematic top view of an active device array substrate according to this embodiment. Referring to FIG. 2, the active device array substrate 100 includes a substrate 110, a first source driving circuit 122, a second source driving circuit 124, a plurality of scan lines 130, a plurality of data lines 140, a plurality of pixel units 150, at least one first repairing line 160, and at least one second repairing line 170.

The substrate 110 includes a display area 112 and a non-display area 114, wherein the display area 112 includes a first area 112a, a second area 112b, and a center area 112c. The first area 112a and the second area 112b are located at two sides of the center area 112c.

The first source driving circuit 122 and the second source driving circuit 124 are disposed in the non-display area 114. In particular, the first source driving circuit 122 and the second source driving circuit 124 are disposed in the non-display area 114 at two opposite sides of the display area 112.

The scan lines 130 are disposed in the display area. The active device array substrate 100 may further include a gate driving circuit 180, and the scan lines 130 are connected to the gate driving circuit 180.

The data lines 140 are disposed in the display area and include a plurality of first data lines 142 and a plurality of second data lines 144. The first data lines 142 are located in the first area 112a and electrically connected to the first source driving circuit 122. The second data lines 144 are located in the second area 112b and electrically connected to the second source driving circuit 124. More specifically, the first data lines 142 and the second data lines 144 are for example respectively driven by the first source driving circuit 122 and the second source driving circuit 124 at two opposite sides of the display area. Therefore, the second data lines 144 and the first data lines 142 are disposed in parallel to each other, for example, and the orientations of the second data lines 144 and the first data lines 142 are reverse to each other. In addition, the second data lines 144 and the first data lines 142 are electrically insulated from each other.

The pixel units 150 are located in the display area 112, and each of the pixel units 150 is electrically connected to one of the scan lines 130 and one of the data lines 140. In other words, each of the pixel units 150 is driven by one of the scan lines 130 and one of the data lines 140, for example. Then, referring to FIG. 2, the active device array substrate 100 of this embodiment is designed to have an hG2D plus dual-portrait structure. A driving method of hG2D is commonly known to persons skilled in the art and thus is omitted hereinafter.

The first repairing line 160 is electrically connected to the first source driving circuit 122. The first repairing line 160 passes through the center area 112c of the display area 112 and overlaps with the first data lines 142, wherein the first repairing line 160 is electrically insulated from the first data lines 142. The first repairing line 160 includes a first repairing section 162 and a first connection section 164. The first repairing section 162 is disposed in the center area 112c of the display area 112 and overlaps with the first data lines 142, wherein the first repairing section 162 is electrically insulated from the first data lines 142.

For example, the first repairing section 162 is disposed perpendicular to the first data lines 142 and spans across a plurality of the first data lines 142, such that the first data lines 142 and the first repairing section 162 have an overlapping area. The first connection section 164 is located in the non-display area 114 and disposed in parallel to the first data lines 142. In this embodiment, the first connection section 164 is disposed between the first repairing section 162 and the first source driving circuit 122. Therefore, the first repairing section 162 and the first source driving circuit 122 are electrically connected to each other via the first connection section 164, for example.

The second repairing line 170 is electrically connected to the second source driving circuit 124. The second repairing line 170 passes through the center area 112c of the display area 112 and overlaps with the second data lines 144, wherein the second repairing line 170 is electrically insulated from the second data lines 144. The second repairing line 170 includes a second repairing section 172 and a second connection section 174. The second repairing section 172 is disposed in the center area 112c of the display area 112 and overlaps with the second data lines 144, wherein the second repairing section 172 is electrically insulated from the second data lines 144.

For example, the second repairing section 172 is disposed perpendicular to the second data lines 144 and spans across a plurality of the second data lines 144, such that the second data lines 144 and the second repairing section 172 have an overlapping area. The second connection section 174 is located in the non-display area 114 and disposed in parallel to the second data lines 144. In this embodiment, the second connection section 174 is disposed between the second repairing section 172 and the second source driving circuit 124. Therefore, the second repairing section 172 and the second source driving circuit 124 are electrically connected to each other via the second connection section 174, for example.

In this embodiment, the display panel 100 of FIG. 1 further includes a light shielding layer 210 disposed between the active device array substrate 100 and the opposite substrate 200, for example. The light shielding layer 210 shields the first repairing line 160 and the second repairing line 170 located in the center area 112c. More specifically, the light shielding layer 210 is for example a black matrix layer, which shields the first connection section 162 and the second connection section 172, or shields a portion of the first connection section 164 and the second connection section 174. Therefore, the user cannot see the first repairing line 160 and the second repairing line 170 in the display area 112. Accordingly, the display quality is not affected by the disposing of the first repairing line 160 and the second repairing line 170.

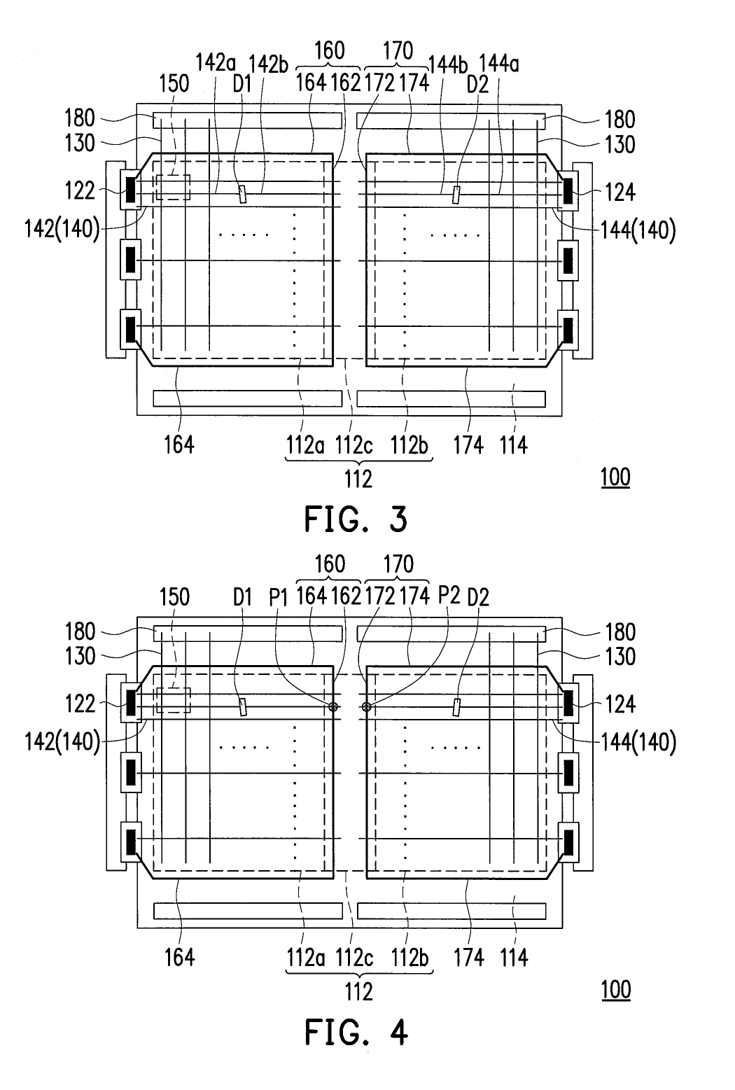

If open circuit occurs on the data lines 140 during the fabricating process of the display panel 10, the display quality of the display panel 10 is seriously affected. Therefore, the invention provides a repairing method for the display panel 10. FIG. 3 illustrates an open circuit defect that occurs on the active device array substrate of the display panel of this embodiment. Referring to FIG. 3, when one of the first data lines 142 has a first open circuit defect D1, the first data line 142 is broken and forms a first data line 142a electrically connected to the first source driving circuit 122 and a first data line 142b electrically insulated to the first source driving circuit 122. The pixel unit 150 connected to the first data line 142a can still be driven and lighted by the first source driving circuit 122, but the pixel unit 150 connected to the first data line 142b cannot be lighted, which causes a defect in the displayed frame.

Thus, a first repairing process P1 is performed on an overlapping area between the first data line 142 having the first open circuit defect D1 and the first repairing line 160, so as to electrically connect the first data line 142 to the first repairing line 160, as shown in FIG. 4. The aforementioned first repairing process P1 is for example a laser welding process. Accordingly, the first data line 142b is electrically connected to the first source driving circuit 122 by the first repairing line 160, and as a result, the pixel unit 150 connected to the first data line 142b is driven and lighted, as shown in FIG. 4. Based on the above, a yield rate of the display panel 10 is improved.

Referring to FIG. 3 again, when one of the second data lines 144 has a second open circuit defect D2, the second data line 144 is broken and forms a second data line 144a electrically connected to the second source driving circuit 124 and a second data line 144b electrically insulated to the second source driving circuit 124. The pixel unit 150 connected to the second data line 144a can still be driven and lighted by the second source driving circuit 124, but the pixel unit 150 connected to the second data line 144b cannot be lighted, which causes a defect in the displayed frame.

Thus, a second repairing process P2 is performed on an overlapping area between the second data line 144 having the second open circuit defect D2 and the second repairing line 170, so as to electrically connect the second data line 144 to the second repairing line 170. The aforementioned second repairing process P2 is for example a laser welding process. Accordingly, the second data line 144b is electrically connected to the second source driving circuit 124 by the second repairing line 170, and as a result, the pixel unit 150 connected to the second data line 144b is driven and lighted. Based on the above, the yield rate of the display panel 10 is improved.

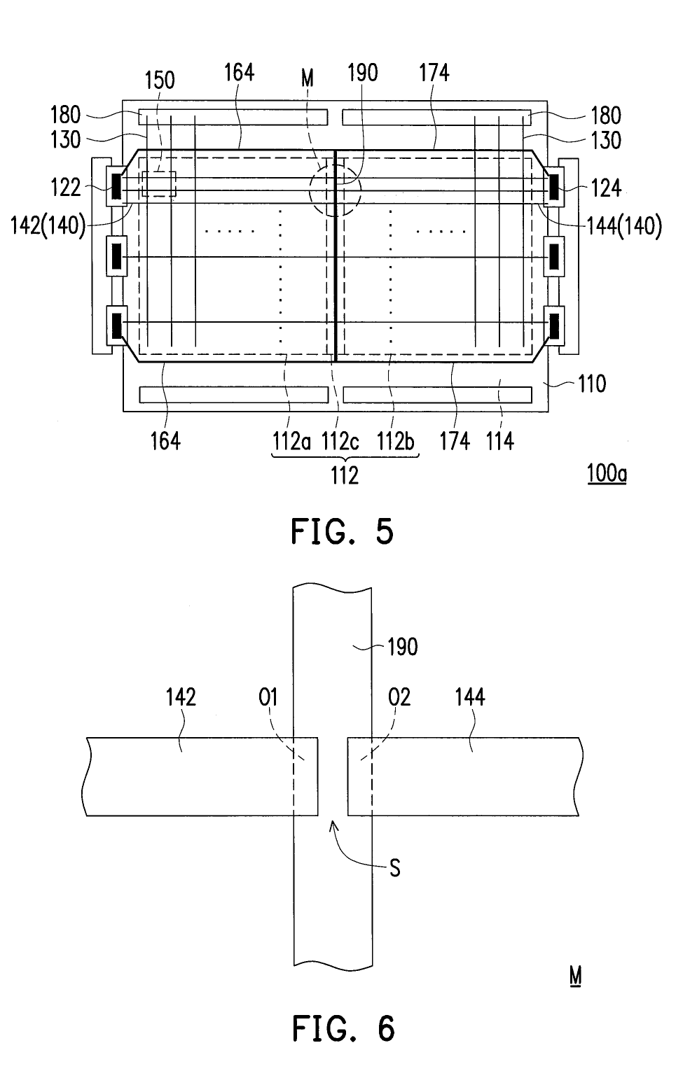

FIG. 5 is a schematic top view of an active device array substrate of a display panel according to another embodiment of the invention. With reference to FIG. 5, an active device array substrate 100a has a structure that is approximately the same as the structure of the active device array substrate 100 of FIG. 2. A difference therebetween lies in that: the first repairing section 162 and the second repairing section 172 in the active device array substrate 100a are combined as a single repairing section 190.

To be more specific, the area of the light shielding layer 210 in the display area 112 is reduced by combining the first repairing section 162 and the second repairing section 172 as the single repairing section 190. Thereby, an aperture ratio of the pixel unit 150 is further improved. FIG. 6 is an enlarged view of an area M of FIG. 5. Referring to FIG. 6, in this embodiment, the first data line 142 overlaps with the single repairing section 190 to form a first overlapping area O1. Moreover, the second data line 144 overlaps with the single repairing section 190 to form a second overlapping area O2. For instance, a space S exists between each of the first data lines 142 and one corresponding second data line 144 above the single repairing section 190. The first data line 142 and the corresponding second data line 144 are electrically insulated from each other.

Referring to FIG. 5 again, in this embodiment, when the first data line 142 or the second data line 144 has the open circuit defect, the repairing process is performed on the first overlapping area O1 or the second overlapping area O2 above the single repairing section 190, so as to electrically connect the first data line 142 or the second data line 144, which has the open circuit defect, to the first source driving circuit 122 or the second source driving circuit 124 via the single repairing section 190. Accordingly, the yield rate of the display panel 10 is increased.

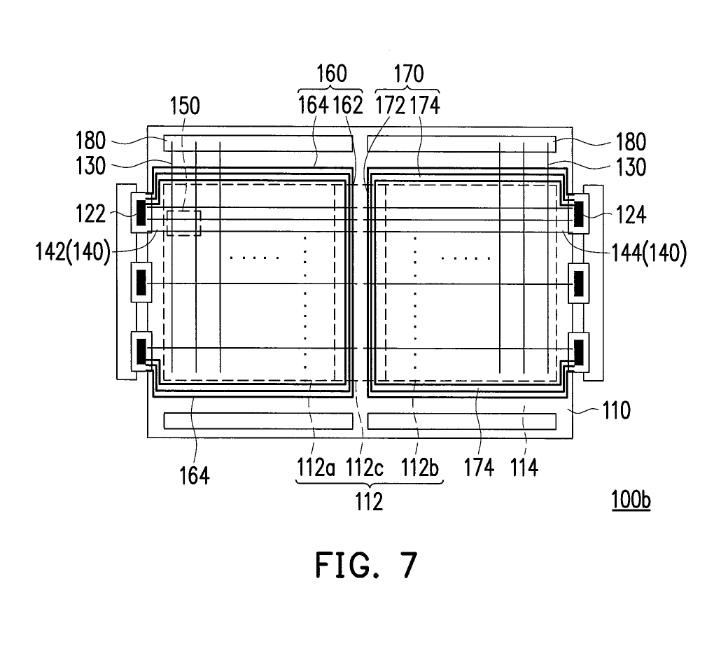

FIG. 7 is a schematic top view of an active device array substrate of a display panel according to yet another embodiment of the invention. With reference to FIG. 7, an active device array substrate 100b has a structure that is approximately the same as the structure of the active device array substrate 100 of FIG. 2. A difference therebetween lies in that: the active device array substrate 100b includes a plurality of the first repairing lines 160, and the first repairing lines 160 all pass through the center area 112c of the display area 112. In addition, the first repairing lines 160 and the first data lines 142 are disposed to overlap with each other and are electrically insulated from each other. More specifically, each of the first repairing lines 160 includes the first repairing section 162 and the first connection section 164. The first repairing sections 162 of the first repairing lines 160 pass through the center area 112c of the display area 112, and the first connection sections 164 of the first repairing lines 160 are located in the non-display area 114.

Since the active device array substrate 100b of this embodiment has the first repairing lines 160, when more than one first data line 142 has the open circuit defect, the repairing process is performed to connect the first connection sections 162 of the first repairing lines 160 to the broken first data lines 142, thereby electrically connecting the broken first data lines 142 to the first source driving circuit 122. Accordingly, the yield rate of the display panel 10 is increased.

In this embodiment, the active device array substrate 100b further includes a plurality of the second repairing lines 170, and the second repairing lines 170 all pass through the center area 112c of the display area 112. In addition, the second repairing lines 170 and the second data lines 144 are disposed to overlap with each other and are electrically insulated from each other. More specifically, each of the second repairing lines 170 includes the second repairing section 172 and the second connection section 174. The second repairing sections 172 of the second repairing lines 170 pass through the center area 112c of the display area 112, and the second connection sections 174 of the second repairing lines 170 are located in the non-display area 114.

Since the active device array substrate 100b of this embodiment has the second repairing lines 170, when more than one second data line 144 has the open circuit defect, the repairing process is performed to connect the second connection sections 172 of the second repairing lines 170 to the broken second data lines 144, thereby electrically connecting the broken second data lines 144 to the second source driving circuit 124. Accordingly, the yield rate of the display panel 10 is increased.

It is noted that the invention is applicable not only to the hG2D structure plus dual-portrait framework but also to a 1G1D structure plus dual-portrait framework. In a display panel having the 1G1D framework, one data line 140 is disposed in one column of pixels. In each column of the pixels, only one pixel is charged during each scan time (1 data, 1D). Thus, N rows of the pixels require N lines of progressive scan times (1 gate, 1G). That is, the charging time for each pixel in the display panel with 1G1D structure is half of the charging time for the display panel with hG2D structure.

In conclusion of the above, the display panel of the invention includes the repairing line disposed in the display area to overlap with the data lines. When open circuit defect occurs on the data lines during the fabricating process of the display panel, the welding process is used to electrically connect the repairing line with the broken data lines, so as to electrically connect the broken data lines to the source driving circuit. Accordingly, the display panel can function properly and the yield rate thereof is improved.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A display panel, comprising:
a substrate comprising a display area and a non-display area, wherein the display area comprises a center area, a first area, and a second area, the first area and the second area being located at two sides of the center area;
a first source driving circuit and a second source driving circuit disposed in the non-display area at two opposite sides of the display area;
a plurality of scan lines disposed in the display area;
a plurality of data lines disposed in the display area and comprising a plurality of first data lines and a plurality of second data lines, wherein the first data lines are disposed in the first area and electrically connected to the first source driving circuit, the second data lines are disposed in the second area and electrically connected to the second source driving circuit, and the second data lines and the first data lines are disposed in parallel to each other and electrically insulated from each other;
a plurality of pixel units disposed in the display area, and each of the pixel units being electrically connected to one of the scan lines and one of the data lines;
at least one first repairing line electrically connected to the first source driving circuit, wherein the first repairing line passes through the center area of the display area and overlaps with the first data lines, and the first repairing line is electrically insulated from the first data lines; and
at least one second repairing line electrically connected to the second source driving circuit, wherein the second repairing line passes through the center area of the display area and overlaps with the second data lines, and the second repairing line is electrically insulated from the second data lines.

2. The display panel according to claim 1, further comprising a light shielding layer which shields the first repairing line and the second repairing line located in the center area.

3. The display panel according to claim 1, wherein the first repairing line comprises:
a first repairing section disposed in the center area of the display area, wherein the first repairing section is electrically insulated from the first data lines and overlaps with the first data lines; and
a first connection section disposed in the non-display area and electrically connecting the first repairing section to the first source driving circuit, and
the second repairing line comprises:
a second repairing section disposed in the center area of the display area, wherein the second repairing section is electrically insulated from the second data lines and overlaps with the second data lines; and
a second connection section disposed in the non-display area and electrically connecting the second repairing section to the second source driving circuit.

4. The display panel according to claim 3, wherein the first repairing section is disposed perpendicular to the first data lines, and the first connection section is disposed in parallel to the first data lines.

5. The display panel according to claim 3, wherein the second repairing section is disposed perpendicular to the second data lines, and the second connection section is disposed in parallel to the second data lines.

6. The display panel according to claim 3, wherein the first repairing section and the second repairing section are combined as a single repairing section.

7. The display panel according to claim 6, wherein a space exists between each of the first data lines and one corresponding second data line above the single repairing section.

8. The display panel according to claim 1, wherein the at least one first repairing line comprises a plurality of the first repairing lines passing through the center area of the display area, and the first repairing lines overlap with the first data lines and are electrically insulated from the first data lines.

9. The display panel according to claim 1, wherein the at least one second repairing line comprises a plurality of the second repairing lines passing through the center area of the display area, and the second repairing lines overlap with the second data lines and are electrically insulated from the second data lines.

10. A repairing method of a display panel, the repairing method comprising:
providing a display panel as claimed in claim 1, wherein one of the first data lines has a first open circuit defect; and
performing a first repairing process on an overlapping area between the first data line having the first open circuit defect and the first repairing line to electrically connect the first data line to the first repairing line.

11. The repairing method according to claim 10, wherein the first repairing process comprises a laser welding process.

12. The repairing method according to claim 10, wherein one of the second data lines has a second open circuit defect; and
a second repairing process is performed on an overlapping area between the second data line having the second open circuit defect and the second repairing line to electrically connect the second data line to the second repairing line.

13. The repairing method according to claim 12, wherein the second repairing process comprises a laser welding process.
